(19) United States
(12) Patent Application Publication
(10) Pub. No.: US 2005/0275323 A1
(43) Pub. Date: Dec. 15, 2005

(54) Electric television lifter

(76) Inventor: Steffi Wilhelm, Unterschonau (DE)

Correspondence Address: Bernard Malina;Malina & Associates, P.C., 60 East 42nd Street, New York, NY, 10165, US

(21) Appl. No.: 11/073,188

(22) Filed: Mar. 4, 2005

Related U.S. Application Data
(60) Provisional application No. 60/578,931, filed on Jun. 10, 2004.

(51) Int. Cl. A47B 88/00; A47B 95/02; H04N 3/12; H04N 5/66

(52) U.S. Cl. 312/319.5

(57) ABSTRACT

A lifter for televisions reversibly lift a flat screen television set from a first lowered position in which the lifter and the television set are hidden within a furniture cabinet to a second raised position in which the lifter supports a flat screen television set above the cabinet for viewing.

This application claims priority from Provisional Patent Application Ser. No. 60/578,931, filed Jun. 10, 2004, entitled “Electric Television Lifter.”

### FIELD OF THE INVENTION

The present invention relates generally to the field of apparatus for mounting television sets and monitors and more particularly, to an apparatus for vertically extending and retracting television sets with large flat screens.

### BACKGROUND OF THE INVENTION

The increased use of television sets with large flat screens in the home has led to a need for appropriate mounting equipment. The conventional mounting of these television sets on a table or attached to a wall like a picture presents the user with a large blank structure which detracts from the overall appearance of a room when the television set is not in use.

### OBJECTS AND SUMMARY OF THE INVENTION

It is an object of the present invention to provide an electric television lifter which can lift a television screen to an elevated viewing position and lower the television set to a retracted position.

Another object of the present invention is to provide an electric television lifter which can retract a television screen into a furniture cabinet.

Another object of the present invention is to provide an electric television lifter which can be operated by remote control.

Yet another object of the present invention is to provide an electric television lifter which comprises a relatively small number of component parts which can be manufactured economically resulting in a relatively low unit cost.

Other objects and advantages of the invention will be apparent hereinafter.

In accordance with the present invention, there is provided an electric television lifter which includes a telescoping vertical frame which supports a pair of horizontal members. The horizontal members include mounting provisions for attachment of a flat screen television set.

The telescoping frame includes a worm screw which is in mesh with a worm nut. The worm screw is driven by an electric motor which is mounted in the frame. A control rod actuates upper and lower limit switches to control the range of vertical travel of the horizontal members. The operation of the electric motor may be controlled by a remote control device which may be a radio or infrared type or a manual switch.

The frame moves the horizontal members and a flat screen television set which is mounted on the horizontal members from a lowered or retracted position in which the frame and the flat screen television set are contained within a furniture cabinet to a raised or extended position in which the flat screen television set is positioned above the cabinet for viewing.

### BRIEF DESCRIPTION OF THE DRAWINGS

Other important advantages of the invention will be apparent from the following detailed description taken in connection with the accompanying drawings in which:

FIG. 1 is a front perspective view of an electric television lifter according to the present invention with the apparatus shown installed in a furniture cabinet and shown holding a television set in a raised position;

FIG. 2 is a front perspective view similar to FIG. 1 showing the television in a lowered position;

FIG. 3 is a perspective schematic view of the electric television lifter of FIG. 1 with both the television and the furniture cabinet shown removed;

FIG. 4 is a rear elevation view taken along the lines 4-4 of FIG. 3;

FIG. 5 is a perspective view of a cross bar member of the electric television lifter of FIG. 1;

FIG. 6 is a fragmentary schematic view showing the micro-switch compartment of the electric television lifter of FIG. 1.

FIG. 7 is an overall rear elevation view of the electric television lifter of FIG. 1; and

FIG. 8 is a front perspective view of an alternative embodiment of an electric television lifter according to the present invention.

### DETAILED DESCRIPTION OF THE INVENTION

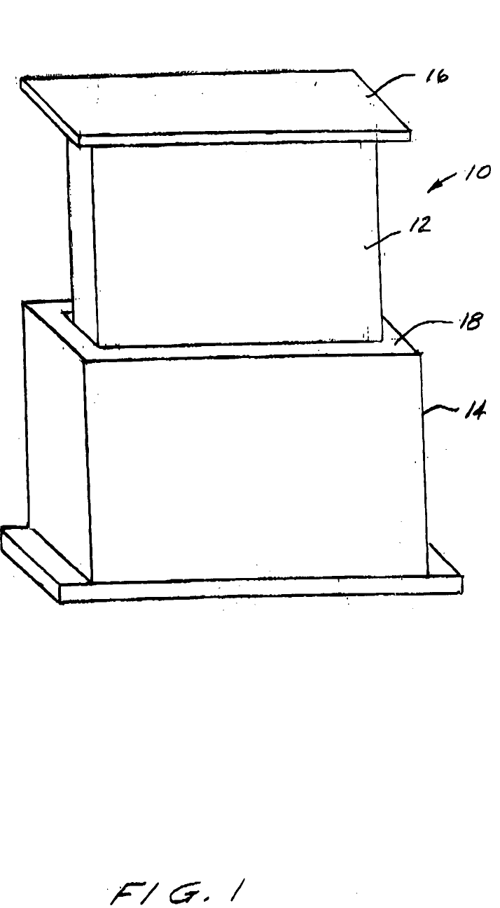

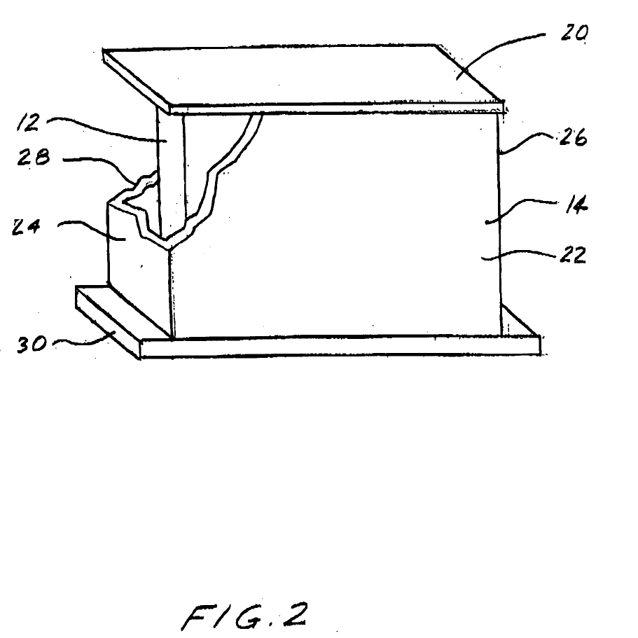

With reference to the drawings, there is shown in FIGS. 1-6 an electric television lifter 10 made in accordance with the present invention. FIGS. 1 and 2 show the electric television lifter 10 in use supporting a television set 12 and mounted in a furniture cabinet 14.

FIG. 2 shows the apparatus 10 in a second or lowered position 20 in which the relatively large flat screen television set 12 which is mounted on the electric television lifter 10 is hidden from view within the furniture cabinet 14. The furniture cabinet 14 includes a solid furniture front panel 22 which hides the television and side panels 24, 26, rear panel 28 and a base 30.

FIG. 1 shows the electric television lifter 10 lifting the television screen 12 to a first or raised position 16 in which the flat screen television set 12 has been raised above the top surface 18 of the furniture cabinet 14 for viewing.

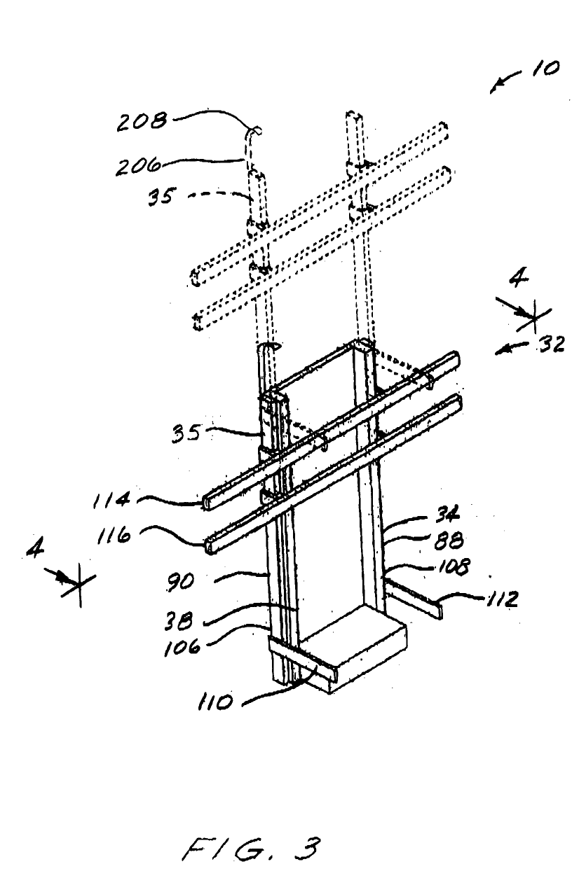

FIG. 3 shows the electric television lifter 10 removed from the furniture cabinet 14 for clarity of illustration. The electric television lifter 10 comprises a frame assembly 32 which includes a first frame 34 and a second frame 35.

The first frame 34 includes a pair of spaced apart vertical members 36, 38. The upper ends 40, 42 of which are connected by an upper cross bar 44. The lower ends 46, 48 of the vertical members 36, 38 are each connected to a motor housing 50 which supports an electric drive motor 52. The motor 52 is connected to a drive screw 54 which is generally centrally disposed between the vertical members 36, 38. The upper end 56 of the drive screw 54 is rotatably supported by the upper cross bar 44.

The motor 52 is preferably a 24 volt DC electric motor which is connected to an electronic unit 58 via a motor cable 60. The electronic unit 58 includes a transformer/converter unit 62 which converts 110 volt AC power to 24 volts DC. The transformer/converter unit 62 includes fuses 64 which are mounted on an outer panel 66 of the electronic unit 58 and a power cord 68 and power plug 70 for connection to a source of electrical power.

The electronic unit 58 can operate at voltages of 110/230 volts or 240 volts and 50/60 Hz. A cable 78 with a double electrical outlet socket 72, 76 provides electrical power to the television set 12 which is mounted in the electric television lifter 10.

The electronic unit 58 is connected to a receiver module 82 via a cable 83. The receiver module cooperates with a conventional remote control transmitter 84 which may be of the radio frequency or infra red type to control the operation of the motor 52.

The upper panel 80 also includes a switch 86 for manual operation of the electric motor 52.

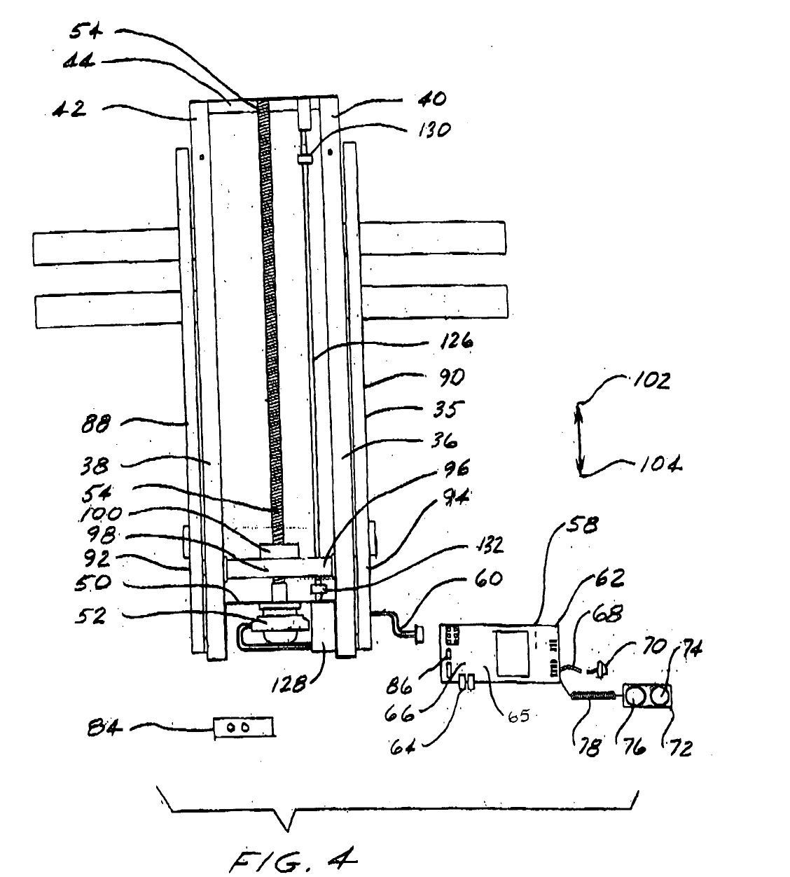

The second frame 35 includes a pair of spaced apart vertical members 88, 90, the lower portions 92, 94 of which are connected by a lower cross bar 96. The central portion 98 of the lower cross bar 96 includes a drive nut 100 which is threaded onto the drive screw 54. Rotation of the drive screw 54 drives the lower crossbar 96 in the directions shown by the arrows 102, 104 in FIG. 4 thereby raising and lowering the vertical members 88, 90.

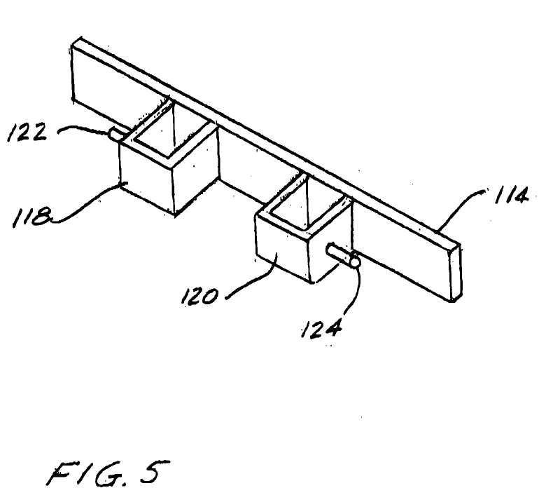

A pair of adjustable crossbars 114, 116 is mounted on the vertical members 88, 90 as is shown in FIG. 5 each of the adjustable crossbars 114, 116 have a pair of mounting brackets 118, 120 which encircle the vertical members 88, 90. The mounting brackets 118, 120 each include a clamp screw 122, 124 which can be adjusted to bear against the vertical members 88, 90 to maintain the position of the adjustable crossbars 114, 116.

During use, the television set 12 rests on the support bars 110, 112 and the adjustable crossbars 114, 116 are used to clamp the television set 12 to the vertical members 88, 90 in a secure manner. The adjustable crossbars 114, 116 may be supplied in different lengths to accommodate television sets of various widths.

A vertical control rod 126 extends between the upper crossbar 44 and the micro switch housing 128. The control rod 126 includes a pair of adjustably mounted adjustment nuts 130, 132. When the upper surface 156 of the lower crossbar 96 comes into contract with the upper adjustment unit 130, the control rod 126 is lifted slightly and the lower end 138 of the control rod 126 which projects into the micro switch housing 140 actuates a micro switch 142 to turn the motor 52 off. In a similar manner, when the lower surface 144 of the cross bar 96 comes into contact with the lower adjustment nut 132 and the control rod 126 is moved in a downward direction to actuate a micro switch 144 in the micro switch housing 136 to turn the motor 52 off.

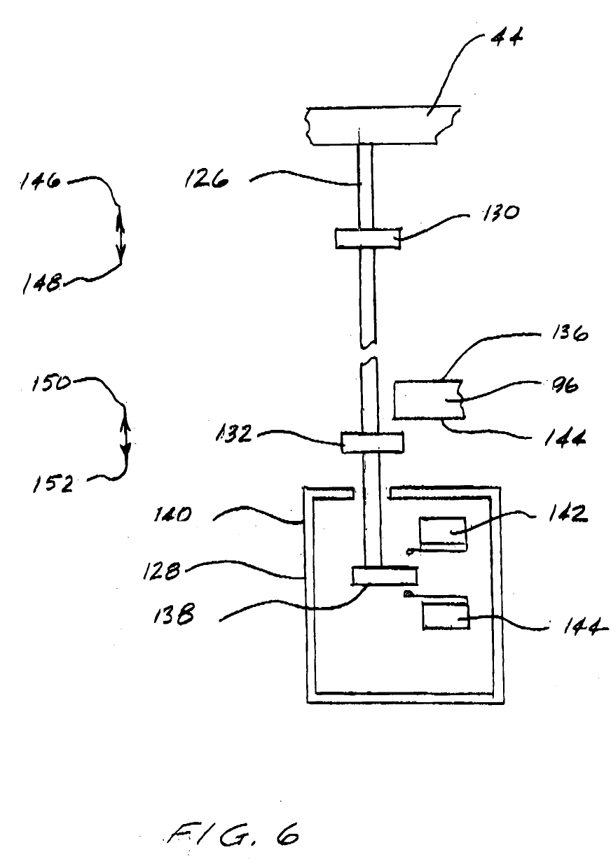

The adjustable nut 130 can be adjusted relative to the control rod 126 in the directions shown by the arrows 146, 148 in FIG. 6. The adjustable nut 132 can be adjusted relative to the control rod 126 in the directions shown by the arrows 150, 152 in FIG. 4. The adjustable nuts 130, 132 thus enable a user to adjust the vertical travel of the electric television lifter 10.

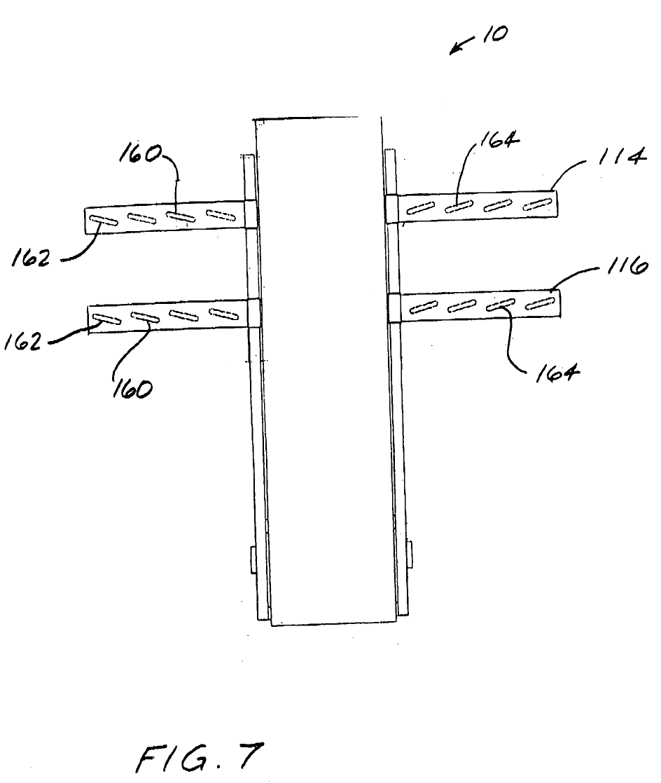

As is best shown in FIG. 7, the adjustable crossbars 114, 116 each include a plurality of diagonally oriented elongated holes 160. The holes 160 are used to attach the television set 12 using conventional bolts, which are not illustrated. The diagonal orientation of the holes 162 on the left side of the apparatus 10, as viewed in FIG. 7, shapes downward to the right while the holes 164 on the right side of the apparatus 10 slopes downward to the left. The diagonal orientation of the holes 162, 164 facilitates centering the television set 12 laterally relative to the apparatus 10 while accommodating a range of television set sizes.

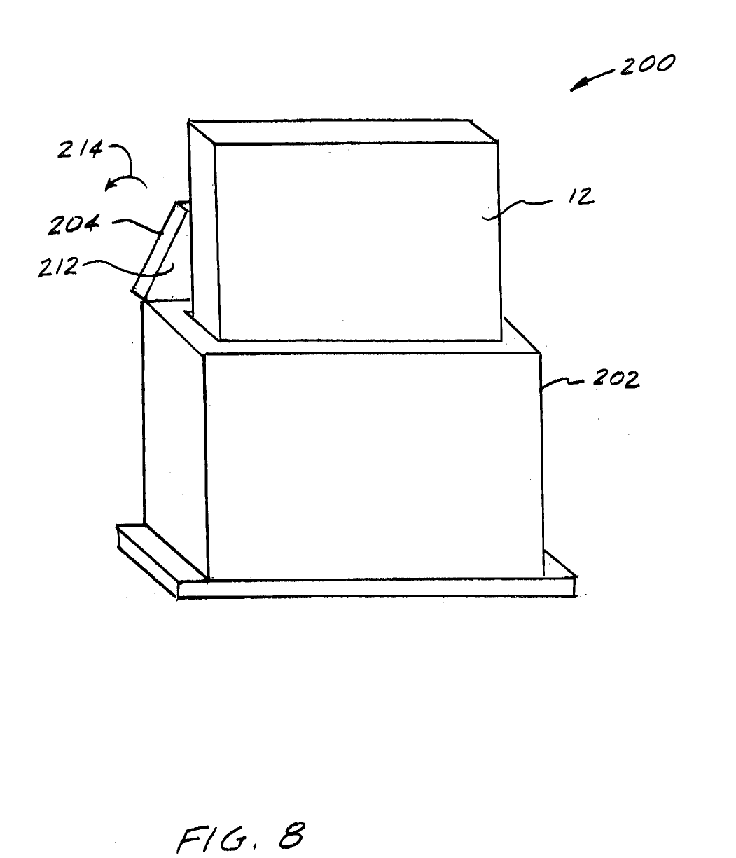

FIG. 8 shows an additional embodiment of the invention 200 in which the furniture cabinet 202 includes a hinged lid 204. A lid opener 206 which has a curved projecting end 208 is attached to the vertical member 90 as is shown in FIG. 3.

When the apparatus 200 is operated to lift the television set 12, the lid opener 206 bears against the inside surface 212 of the lid 204 and forces the lid 204 to open in the direction shown by the arrow 214. Lowering the television set 12 allows the lid 204 to close.

The various specific embodiments of the present invention are for illustrative purposes only. Various changes and modifications may be made within the spirit and scope of the present invention.

1. An electric television lifter comprising:
a frame assembly with said frame assembly comprising a first frame portion; and
a second frame portion with said second frame portion movably disposed relative to said first frame portion;
attachment means disposed on said second frame portion;
drive means mounted on said first frame portion for reversibly driving said second frame portion from a first lowered position to a second raised position.

2. The electric television lifter as claimed in claim 1 wherein said drive means comprises electric motor drive means.

3. The electric television lifter as claimed in claim 1 wherein said drive means comprises a drive screw connected to said second frame portion; and
a drive nut with said drive nut in threaded engagement with said drive screw and with said drive nut connected to said drive means whereby rotation of said drive nut causes said drive screw to reversibly drive said second frame portion from said first lowered position to said second raised position.

4. The electric television lifter as claimed in claim 1 wherein said attachment means comprises a crossbar; and
attachment means for adjustably attaching said crossbar to said second frame portion.

5. The electric television lifter as claimed in claim 4 wherein said attachment means further comprises a support bar mounted on said second frame portion.

6. The electric television lifter as claimed in claim 1 further comprising remote control means for operating said drive means.

7. The electric television lifter as claimed in claim 1 wherein each of said frame portions each comprise a rectangular frame portion.

8. The electric television lifter as claimed in claim 1 wherein said first frame portion and said second frame portion are disposed in a telescoping relationship.

9. The electric television lifter as claimed in claim 1 further comprising a cabinet with said frame assembly disposed in said cabinet with said frame assembly substantially hidden within said cabinet when said frame assembly is in said first lowered position and with said second frame portion projecting above said cabinet when said frame assembly is in said second, raised position.

10. The electric television lifter as claimed in claim 9 wherein said cabinet further comprises a hinged lid.

11. The electric television lifter as claimed in claim 10 further comprising a lid lifter disposed projecting from said second frame portion and disposed to bear against and open said hinged lid when said second frame portion is driven to said second raised position.
